(19) United States
(12) Patent Application Publication
(10) Pub. No.: US 2006/0068231 A1
(43) Pub. Date: Mar. 30, 2006

(54) Magnetic recording medium and method for manufacturing the same

(75) Inventor: Yasushi Hattori, Kanagawa (JP)

Correspondence Address: TAIYO CORPORATION, 401 HOLLAND LANE, #407, ALEXANDRIA, VA, 22314, US

(73) Assignee: FUJI PHOTO FILM CO., LTD.

(21) Appl. No.: 11/236,726

(22) Filed: Sep. 28, 2005

(30) Foreign Application Priority Data
Sep. 30, 2004 (JP) 2004-288560

(51) Int. Cl. G11B 5/65; B05D 5/12

(52) U.S. Cl. 428/836.2; 428/848.5; 427/127; 427/282

(57) ABSTRACT

The invention is a magnetic recording medium which contains magnetic regions and non-magnetic regions. There are two or more of the magnetic regions with each of the regions containing a ferromagnetic ordered alloy, of either a CuAu-type or Cu₃Au-type, and a matrix agent, and each of the magnetic regions is formed as a physically separate shape. The invention also includes a manufacturing method for manufacturing the magnetic recording medium which comprises forming magnetic regions using a mask which uses a photopolymer to form the magnetic regions containing the ferromagnetic ordered alloy, of either a CuAu-type or Cu₃Au-type, and the matrix agent.

### CROSS-REFERENCE TO RELATED APPLICATION

This application claims priority under 35 USC 119 from Japanese Patent Application No. 2004-288560, the disclosure of which is incorporated by reference herein.

### BACKGROUND OF THE INVENTION

1. Field of the Invention

The present invention relates to a manufacturing method for a magnetic recording medium, and in particular to a magnetic recording medium of a so called patterned media and a manufacturing method thereof.

2. Description of the Related Art

The following points are problems when increasing the density of magnetic recording media. First, for high density recording, whilst it has become possible to make the size of magnetic elements small, there is a fear that with a reduction in the size of the magnetic elements that ferromagnetism will disappear due to thermal fluctuations. Also, along with increasing the recording density, transition noise becomes a problem.

It has been proposed to use CuAu-type or Cu₃Au-type ferromagnetic ordered alloys to try to overcome the thermal fluctuations. However, since this type of magnetic body is nonmagnetic or soft magnetic at the time of synthesis, in order to make it in a hard magnetic usually it is necessary to carry out an annealing process at over 500° C. Because of this, at the stage of carrying out annealing at high temperature the particles themselves tend to fuse together and make large particles, and hence the fundamental goal of reducing the size of the particles cannot be achieved. Here, expressions of “CuAu-type” and “Cu₃Au-type” are well known in the art. Reference can be made to literature such as J. Appl. Phys., 93(1), 453-457 (2003) and Jpn. J. Appl. Phys., 39, part 2, No. 11B 1121-1123 (2000).

Also, proposed as an important counter measure against transition noise is patterned media. As patterned media, first there is proposed a pattern, which becomes the magnetic elements, formed as projections on a support medium (such as for example in Japanese Patent No. 1888363). However, this mode is considered to be disadvantageous to the traversing of a flying head due to projections being formed on the surface.

Also disclosed is a method of forming a magnetic thin layer in grooved trenches formed on a substrate (see, for example, JP-A No. 2001-110050). In this method, the patterned media is prepared by (1) a substrate being covered with a mask pattern, (2) grooved trenches being formed in the substrate by etching processing, and then (3) a magnetic thin layer being formed by sputtering or the like, (4) and removing the mask pattern. It can be said that the surface is superior from the perspective of smoothness. However, in this method, the mask pattern makes projections relative to the substrate, and during the forming of the magnetic thin layer by sputtering the thin layer is preferentially formed on the projecting areas. The thin layer formed on the projected portions is removed along with the removal of the mask pattern, and so there is the problem that it is disadvantageous in terms of productivity.

### SUMMARY OF THE INVENTION

The present invention has been made in view of the above circumstances and provides a magnetic recording medium and a manufacturing method thereof which reduces transition noise whilst preventing aggregation of magnetic particles, and which has high productivity.

That is, the present invention is a magnetic recording medium which has magnetic regions and nonmagnetic regions, with 2 or more magnetic regions which include CuAu-type or Cu₃Au-type ferromagnetic ordered alloy and matrix agent, and where each of the magnetic regions is formed as physically separate shapes.

It is preferable that the magnetic regions are formed in depressions formed on a substrate, and also preferable that inside the magnetic regions magnetic particles of CuAu-type or Cu₃Au-type ferromagnetic ordered alloy are arrayed in an ordered manner.

Further, in the magnetic recording medium manufacturing method of the invention, there is included a magnetic region forming process which uses a mask using a photopolymer for forming the magnetic regions containing CuAu-type or Cu₃Au-type ferromagnetic ordered alloy and matrix agent.

### BRIEF DESCRIPTION OF THE DRAWINGS

FIG. 1 is a plan view showing one area of a magnetic recording medium of the invention;

FIGS. 2A, 2B-1, 2B-2, 2C, 2D and 2E are explanatory process diagrams showing a magnetic region forming process of the invention;

FIGS. 3A, 3B-1, 3B-2, 3D′ and 3E′ are explanatory process diagrams showing another example of a magnetic region forming process of the invention;

FIG. 4 is a photograph showing a self-organizing condition.

### DETAILED DESCRIPTION OF THE INVENTION

[Magnetic Recording Medium]

The magnetic recording medium of the present invention has magnetic regions and nonmagnetic regions, with 2 or more magnetic regions which include CuAu-type or Cu₃Au-type ferromagnetic ordered alloy and matrix agent, and where each of the magnetic regions is formed as physically separate shapes. By physically separating the regions in this way, transition noise can be reduced.

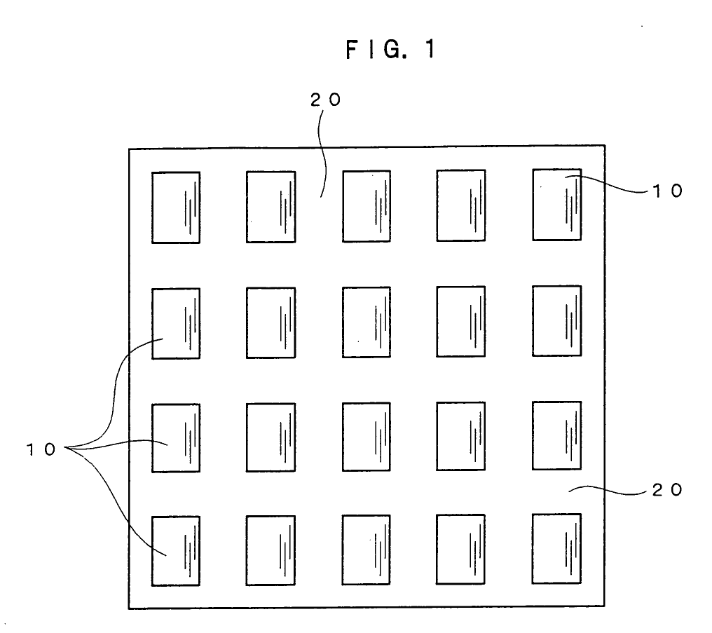

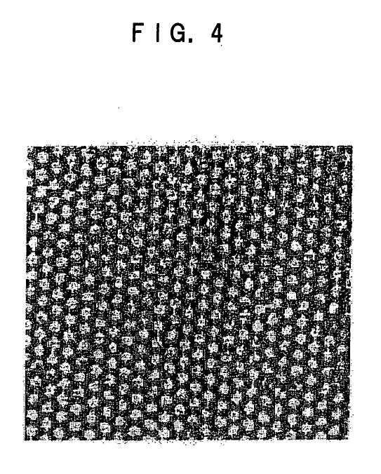

In the invention, by “magnetic regions are formed as physically separate shapes” it is meant, as shown in FIG. 1, that an essentially nonmagnetic material (nonmagnetic region 20) is present between magnetic regions 10. For example, if the magnetic regions 10 are formed as projections from the support medium, then the nonmagnetic regions are air, and when the magnetic regions are buried in the support medium then the nonmagnetic regions are the support medium, or the matrix layer mentioned above. Regarding the size of the magnetic regions, when these regions are spot or line shape, then the width is preferably from 20 to 1000 nm, and more preferably from 25 to 500 nm. In order to greatly improve the reduction in transition noise it is preferable that the magnetic regions are magnetically independent. For this reason, it is desirable that the magnetic regions are separated. If they are separated too much then the recording density is reduced, and the separation (minimum separation) is preferably between 5 and 200 nm, and more preferably 10 to 100 nm. Another example of “magnetic regions formed as physically separate shapes” is shown in the photograph of FIG. 4 showing “self-organization” (particle size 5 nm).

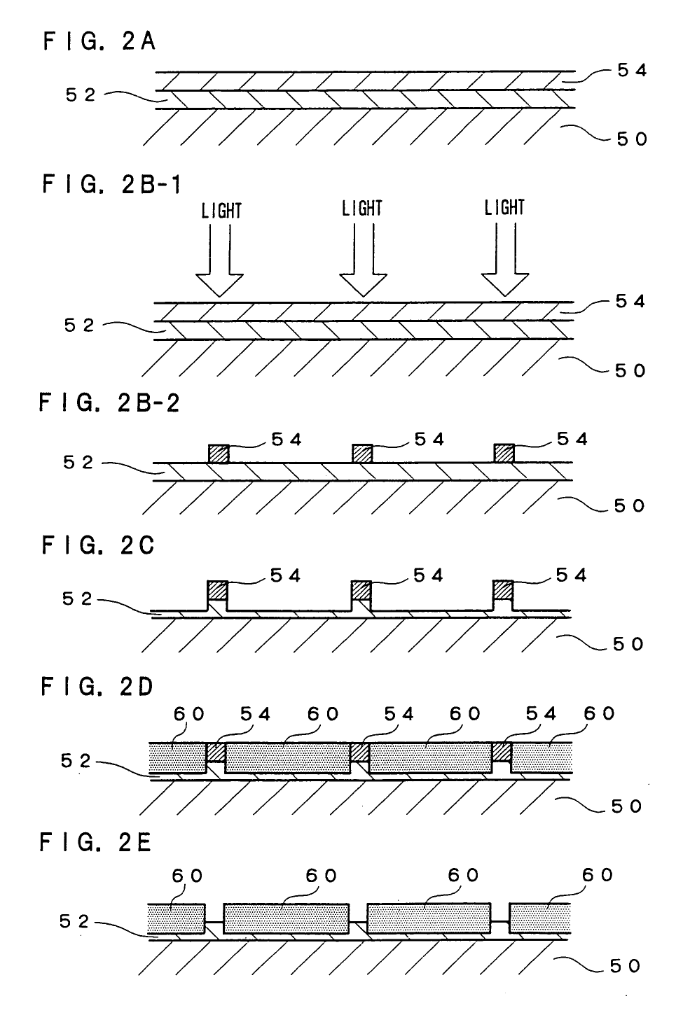

First, as is shown in FIG. 2A, a matrix layer 52 is formed on a support medium 50, and above the matrix layer 52 is formed a resist film 54 composed of a photopolymer. The matrix layer 52 can be formed by a conventional method (for example sputtering and the like). The thickness of the matrix layer is preferably between 5 and 200 nm.

Here, for materials from which to form the matrix layer 52, it is particularly appropriate, for example, to use sputtering for thin film forming with examples of the materials given below.

Examples which can be given of these materials are: amorphous carbon; amorphous silicon; amorphous germanium; amorphous selenium; amorphous tellurium; carbon group binary or poly alloys adjusted to make readily amorphous with the addition to carbon of impurities such as silicon, nitrogen, hydrogen, germanium, selenium, tellurium, and the like; silicon group binary or poly alloys adjusted to make readily amorphous with the addition to silicon of impurities such as carbon, nitrogen, hydrogen, germanium, selenium, tellurium, and the like; germanium group binary or poly alloys adjusted to make readily amorphous with the addition to germanium of impurities such as carbon, silicon, nitrogen, hydrogen, selenium, tellurium, and the like.

When forming the pattern of the resist layer 54 a conventional material can be used as the photopolymer, but in order to get an efficient coating liquid flow into grooves (between resist layer and resist layer in FIG. 2C), it is preferable that a lipophobic polymer is used.

Specific examples of compounds which can be used are 1) hydrophilic binders with polymerizable groups, 2) hydrophilic monomers, 3) polymers which contain hydrophilic initiators. Further, PTFE (Polyterafluoroethylene), PFA (Copolymers of Tetrafluoroethylene with Perfluoroalkoxy Vinyl Ether), ETFE (Copolymers of Ethylene with Terafluoroethylene), and fluoropolymers (trade name: SAITOP; manufactured by Asahi Glass) are preferably used. Fluoropolymers are superior in transparency in the ultraviolet region when precision processing photopolymers, and also superior from the perspective of photopolymer processing. Regarding the thickness of the resist layer 54, it is preferable that the thickness is between 50 and 5000 nm.

Next, as is shown in FIG. 2 B-1, electron beam exposure or light exposure is carried out according to a prescribed bit pattern. After this, as is shown in FIG. 2 B-2, a pattern mask is formed with the bit pattern array, by carrying out development processing.

Continuing, as required, as is shown in FIG. 2C, selective etching of the matrix layer not covered by the pattern mask is carried out by a reactive ion etching method, and the matrix layer 52 is formed with the bit array pattern which is built into the resist mask.

As shown in FIG. 2 D, a coating layer 60 which can provide the magnetic regions is formed by coating with a coating liquid in which is dispersed alloy particles of ferromagnetic bodies or bodies from which ferromagnetic bodies can be obtained (CuAu-type or Cu₃Au-type ferromagnetic ordered alloys) by a conventional method (for example spin coating). After forming the coating layer, by using a liquid containing 20 ppm or more of ozone to dissolve away the pattern mask as the resist mask, a bit array of alloy particles of bodies from which ferromagnetic bodies can be formed (CuAu-type or Cu₃Au-type ferromagnetic ordered alloys can be formed) is formed, as is shown in FIG. 2 E. The magnetic regions (before annealing these correspond to the coating layer 60) are independently formed in the depressions in the matrix layer 52. In this case, between the magnetic regions the matrix layer 52 is present. By carrying out such a magnetic region forming process, magnetic regions can be formed efficiently, and high productivity for a magnetic recording medium can be obtained.

The above coating liquid is, the alloy particle-containing liquid of the following explanation of the manufacturing method to which is incorporated a matrix agent. By including a matrix agent, the coating layer can be formed at a relatively low temperature. The matrix agent, when the solids content is 1%, is preferably added at a rate of between 10 to 200 μm per 1 ml of the alloy particle-containing liquid.

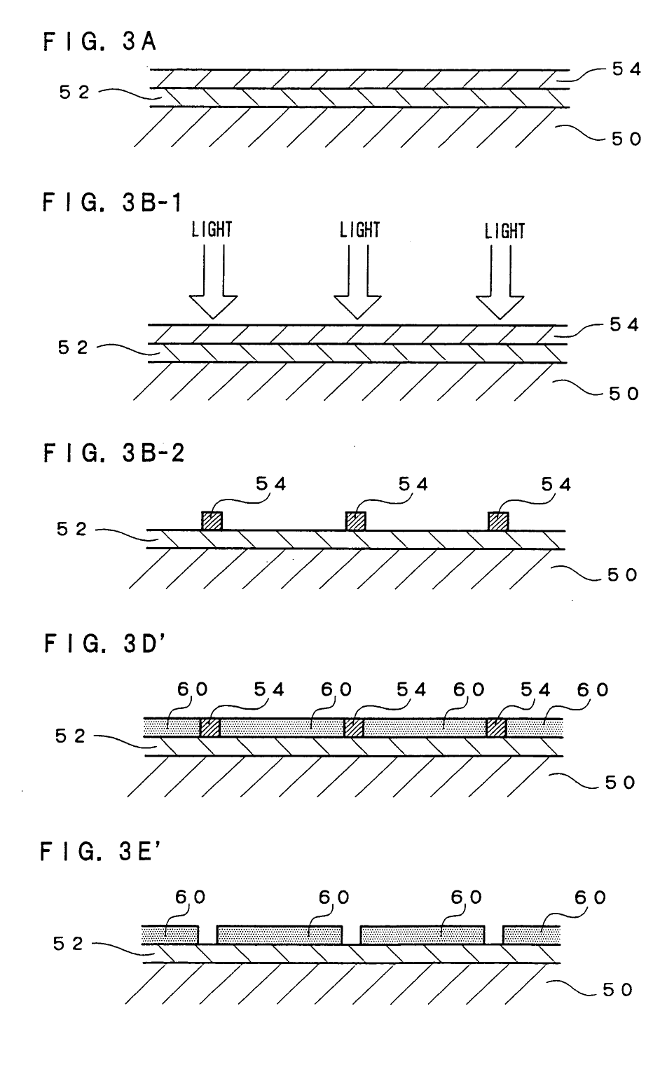

Further, the coating layer for the magnetic regions can be formed without carrying out the selective etching of the matrix layer 52 treatment shown in FIG. 2C, as is shown in FIG. 3. That is, as is shown in FIG. 3 (B-2), after carrying out the development processing and forming of the pattern mask, the coating layer 60 can be formed to obtain the magnetic regions, without carrying out the selective etching of the matrix layer 52, as is shown in FIG. 3D′. Following this, in the same way as in FIG. 2E, the patterned matrix can be dissolved away to form the independent magnetic regions on the mask layer 52, as is shown in FIG. 3E′. In this case, the nonmagnetic regions become the occurrences of air.

In FIGS. 3A to 3E′, portions corresponding to those of FIGS. 2A to 2E have reference numerals identical with those of FIGS. 2A to 2E.

Then, in order to harden the coating film, it is dried at a temperature of between 100 and 300° C. If the drying is carried out in air then an oxidizing effect on the coating film can also be obtained. After drying, in order to make the alloy particles into ferromagnetic bodies, annealing treatment is carried out. Then the magnetic recording medium of the invention can be manufactured by, where necessary, forming a protective layer, and coating a lubricant onto the protective layer by a conventional method.

The magnetic regions of the invention can be formed by including a conventional matrix agent in the coating liquid, but it is preferable that a metal oxide matrix agent is used being superior in heat resistance.

It is preferable that a metal oxide matrix is nonmagnetic. By being nonmagnetic, contact between magnetic particles, having single magnetic domain structures, does not occur, and the effect of a reduction in the transition noise during recording can be obtained.

For the nonmagnetic metal oxide matrix, at least one type of a matrix agent selected from the group consisting of silica, titania or polysiloxane is preferable. Specifically it is preferable that the matrix agent is at least one type of matrix agent selected from the group consisting of organo-silica sols (for example, Trade Name: ORGANOSILICASOL, manufactured by Nissan Chemicals; and, Trade Name: NANOTEC SiO₂, manufactured by CI Kasei Co.), organo-titania sols (for example, Trade Name: NANOTEC TiO₂, manufactured by CI Kasei Co.) and silicone resins (for example, Trade Name:TOREFIL R910, manufactured by Toray Industries Inc.). The above materials are effective in increasing the resistance to scratches and adhesion of the magnetic layer. If the above matrix agents are the main components then, in addition to these, various known additives can be added into the magnetic layer.

As has been already stated, in the magnetic recording medium of the present invention, the magnetic layer, which contains the matrix magnetic particles which are formed from CuAu-type or Cu₃Au-type ferromagnetic ordered alloy, is formed on a support.

Here, it is possible to maintain a condition of high adhesion of the magnetic layer with the support since the metal oxide compound matrix exhibits the role of a binder, even when carrying out annealing to form the ferromagnetic ordered alloy. Further, even when annealing treatment is carried out, the constitution of the metallic oxide compound matrix does not alter, and since a strong magnetic layer is formed, deterioration of layer strength due to the carbonization of organic dispersant or polymer can be suppressed and scratch resistance can be improved.

Further, by including the magnetic particles into the matrix agent of the metal oxide matrix and the like, the magnetic particles do not aggregate together, and a condition of a high degree of dispersion can be maintained, and ferromagnetism can be effectively realized.

Regarding the amount of addition of the matrix agent, this should be 1 to 50% by volume relative to the total volume of the magnetic particles, preferably 2 to 30%, and more preferably 3 to 20%. With regard to the method for forming the magnetic layer (method for preparing the alloy particles and the conditions of annealing and the like), these will be explained later in “Manufacturing method of the magnetic recording medium”.

Also, as stated above, a protective layer may be formed on the magnetic layer to improve the abrasion resistance. Further still, a lubricant may also be applied onto the protective layer to increase the sliding properties so that the resulting magnetic recording medium can have sufficient reliability.

Examples of the material for the protective layer include oxides such as silica, alumina, titania, zirconia, cobalt oxide, and nickel oxide; nitrides such as titanium nitride, silicon nitride and boron nitride; carbides such as silicon carbide, chromium carbide and boron carbide; and carbon such as graphite and amorphous carbon. Preferable are materials containing at least one of C or Si.

Examples of materials which contain at least one of C or Si which can be given are; Si compounds, such as, silica, silicone nitride; carbide compounds such as silicon carbide, chromium carbide, boron carbide; and carbon compounds such as graphite, and amorphous carbon. Particularly preferable is so called diamond-like carbon which is a hard amorphous form of carbon. Also, it is also possible to form structure with a sol-gel film which includes Si or C.

A protective carbon film made of carbon can have sufficient resistance to abrasion even when very thin, so that seizing-up of a sliding member due to heat does not easily develop. Thus, carbon lends itself particularly well to being a material for the protective layer.

A protective carbon film is generally formed by a sputtering method in the case of a hard disk. A number of methods using a high deposition rate plasma CVD technique are proposed for a product which has to be formed through a continuous film formation, such as a video tape. Thus, any of these methods is preferably used.

Among these, it is reported that a plasma injection CVD (PI-CVD) method can form a film at very high speed and can produce a hard protective carbon film with less pinholes and with good quality (for example, see JP-A Nos. 61-130487, 63-279426 and 03-113824), the disclosures of which are incorporated by reference herein.

The protective carbon film preferably has a Vickers hardness of more than 1000 kg/mm², more preferably of more than 2000 kg/mm². Preferably, it has an amorphous structure and is non-electrically conductive.

When a diamond-like carbon film is used as the protective carbon film, its structure can be determined by Raman spectroscopic analysis. That is, when a diamond-like carbon film is measured, the structure can be confirmed by the detection of a peak at a wave number of 1520 to 1560 cm⁻¹. As the structure of a carbon film deviates from a diamond-like structure, the peak detected by the Raman spectroscopic analysis deviates from the above range, and the hardness of the protective layer also decreases.

Preferred carbon materials for use in forming the protective carbon film include carbon-containing compounds such as: alkanes, such as methane, ethane, propane, and butane; alkenes, such as ethylene and propylene; and alkynes, such as acetylene. A carrier gas such as argon or an additive gas for improving the film quality, such as hydrogen and nitrogen may be added as required.

If the protective carbon film is too thick, the electromagnetic transfer characteristics can be degraded, or its adhesiveness to the magnetic layer can be reduced. If the film is too thin, its abrasion resistance can be insufficient. Thus, the film preferably has a thickness of 2.5 to 20 nm, more preferably of 5 to 10 nm.

In order to improve the adhesiveness between the protective layer and the magnetic layer to be a support, it is preferred that the surface of the magnetic layer should be improved in advance by etching with an inert gas or modified by exposure to a reactive gas plasma such as an oxygen plasma.

In order to improve the running durability and the corrosion resistance, a lubricant layer is formed on the protective layer. The lubricant to be added to form the lubricant layer may be a known hydrocarbon lubricant, a known fluoro-lubricant, a known extreme-pressure additive, or the like. The lubricant layer preferably contains fluorine.

Examples of the hydrocarbon lubricant include: carboxylic acids, such as stearic acid and oleic acid; esters, such as butyl stearate; sulfonic acids, such as octadecyl sulfonic acid; phosphates, such as monooctadecyl phosphate; alcohols, such as stearyl alcohol and oleyl alcohol; carboxylic amides, such as stearic acid amide; and amines, such as stearylamine.

Preferable examples of the fluoro-lubricant for use in the present invention include modifications of the above hydrocarbon lubricants in which part or the whole of the alkyl group is substituted with a fluoroalkyl group or a perfluoropolyether group.

The perfluoropolyether group may be a perfluoromethylene oxide polymer, a perfluoroethylene oxide polymer, a perfluoro-n-propylene oxide polymer (CF₂CF₂CF₂O)ₙ, a perfluoroisopropylene oxide polymer (CF(CF₃)CF₂O)ₙ, or any copolymer thereof.

The lubricant layer of the present invention is mainly composed of a fluorine based lubricant, and the thickness of the layer is preferably about 2 to about 20 nm, more preferably about 5 to about 10 nm.

The hydrocarbon lubricant may have a polar functional group such as a hydroxyl group, an ester group or a carboxyl group at the end of the alkyl group or in its molecule. Such a compound is preferred because it can be highly effective in reducing the frictional force.

Its molecular weight may be from 500 to 5000, preferably from 1000 to 3000. If the molecular weight is from 500 to 5000, the volatilization can be suppressed, and a high lubricity can also be maintained. In addition, accidental stopping of the running or head crashing can be prevented by avoiding the adherence of the disk to a slider.

For example, such a perfluoropolyether is commercially available under the trade name of FOMBLIN (trade name, manufactured by Ausimont) or KRYTOX (trade name, manufactured by DuPont).

Examples of the extreme-pressure additive include phosphates such as trilauryl phosphate, phosphites such as trilauryl phosphite, thiophosphates and thiophosphites such as trilauryl trithiophosphite, and a sulfur extreme-pressure agent such as dibenzyl disulfide.

These lubricants may be used alone or in combinations. Any of these lubricants may be applied to the protective layer by applying a solution of the lubricant in an organic solvent by a wire-bar coating method, a gravure coating method, a spin coating method, a dip coating method, or the like, or by depositing the lubricant by a vacuum vapor deposition method.

Also, in addition to the lubricant, anti-corrosion agents may be used. Examples of the anti-corrosion agent include: nitrogen-containing heterocyclic compounds, such as benzotriazole, benzimidazole, purine, and pyrimidine, and derivatives thereof in which an alkyl side chain is introduced to the main ring; and nitrogen and sulfur-containing heterocyclic compounds, such as benzothiazole, 2-mercaptobenzothiazole, tetrazaindene cyclic compounds, and thiouracil compounds, and derivatives thereof.

In order to improve the electromagnetic conversion characteristic, it is also possible to construct multiple layers, or to put a non-magnetic layer or conventional intermediate layer under the magnetic layer. In order to construct multiple layers, it is possible to undertake coating multiple times with a coating liquid using the process for forming magnetic areas which has been described above.

If a nonmagnetic layer is formed between the support and the magnetic layer, it is preferable that this nonmagnetic layer contains at least one type of compound selected from the group consisting of metal alkoxide compounds, metal phenoxide compounds, and coupling agents.

For the above metal alkoxide compounds and above metal phenoxide compounds, it is preferable that they contain in the molecules at least 2 reaction groups which bond to inorganic substances.

For the above coupling compounds, it is preferable that they contain in the molecules at least 2 reaction groups and that at least one of these reaction groups bonds to inorganic substances, and at least one of the remaining groups bonds to organic substances, and by doing so bridging takes place between organic and inorganic substances.

Below, “compound for the nonmagnetic layer” will be used for the combined meaning of metal alkoxide compounds, metal phenoxide compounds, and coupling agents.

It is preferable that the compound for the nonmagnetic layer is a compound represented by Formula (I) below.
M-(R)n Formula (I)
In Formula (I), M represents a metal atom of valency from 3 to 5, n represents an integer which corresponds to the valency of the metal. Rs can be the same or different from each other, and at least one of them represents an alkoxy or a phenoxy group. M represents a metal atom of valency from 3 to 5, and the metal can be selected from Group IIIA, Group IIIB, Group IVA, Group IVB, Group VA, and Group VB. Preferable metals are Si, Ge, Sn, Pb, Ti, V, Al, Ga, In, Sb, and Bi.

The alkoxy group represented by R is preferably a group with 8 carbon atoms or fewer, and can be selected from the group consisting of a methoxy group, a ethoxy group, a isopropoxy group, an n-propoxy group, a t-butoxy group, and an n-butoxy group. Multiple alkoxy groups can be the same as or different from each other. Also, the alkoxy or phenoxy groups may have further substitution groups. The remaining substituent groups represented by R can be arbitrarily selected but it is preferable that they are groups which have an absorbent terminal group and have 8 carbon atoms or fewer. As absorbent groups examples include —SH, —CN, —NH₂, —SO₂OH, —SOOH, —OPO(OH)₂, —COOH, and the like.

Specific examples of compounds for the nonmagnetic layer are listed below, but the magnetic layer compounds are not restricted to those listed.

Tetraethoxyorthosilane, N-(2-aminoethyl)-3-aminopropyl methyl dimethoxysilane, N-(2-amonoethyl)-3-aminopropyl trimethoxysilane, 3-aminophenoxy dimethyl vinylsilane, aminophenyl trimethoxysilane, 3-aminopropyl triethoxysilane, bis(trimethoxysilylpropyl)amine, (p-chloromethyl) phenyl trimethoxysilane, (3-glycidoxypropyl) trimethoxysilane, titanium dichloride diethoxide, tetraethoxytitanium, tetra-n-butoxygermane, 3-mercapto propyl triethoxygermane, 3-methacryl oxypropyl triethoxygermane, aminophenyl aluminium dimethoxide, 3-aminopropyl germanium diethoxide, aminopropyl indium dimethoxyethoxide, tetra isopropoxy tin-isopropanol adduct, 3-glycidoxypropyltriethoxy tin, 3-methacryloxypropyl tri-t-butoxy tin, n-(2-aminoethyl)-3-aminopropylmethyl dimethoxy tin, vinyl-tris (2-ethoxymethoxy) lead (IV), 3-methacryl oxypropyl tetramethoxy antimony (V), 3-mercapto propyl bismuth (III) di-t-pentoxide, 3-aminopropyl vanadium dibutoxyoxide, aminopropyl indium dimethoxyethoxide.

The coating liquid is prepared by dissolving the compound for the nonmagnetic layer in a mixed solvent of water and an alcohol. Then, this coating liquid is coated onto the support to form a nonmagnetic layer. A pH adjuster and binder can be included in the coating liquid, as the need arises. The coating amount of the compound for the nonmagnetic layer can be arbitrarily set, however it is preferably between 0.1 and 10 g/m². The compound for the nonmagnetic layer, due to the hydrolysis or dehydration condensation of the alkoxy group or phenoxy group, strongly covers the surface of the support with metal compound, at the same time adsorbs the nanoparticles coated thereon. As a result, there is strong adhesion to the magnetic layer.

The magnetic recording medium of the invention can have the magnetic layer and one or more additional layers, as required. For example, in the case of a disc, it is preferable that on the surface of the side opposite to the magnetic layer, a further magnetic layer or non-magnetic layer is provided. In the case of a tape, it is preferable that on the surface of insoluble support on the side opposite to the magnetic layer, a back layer is provided.

In the case that the magnetic recording medium is a tape or the like, it is possible to provide a back coat layer (backing layer) on the surface of the nonmagnetic support on the side opposite to the one on which the magnetic layer is formed. This back coat layer is a layer provided by coating a back coat layer-forming coating, containing a powder-like composition of an abrasive, anti-electrostatic agent or the like and a binder dispersed in a known organic solvent, onto the surface on the side of the nonmagnetic support opposite to the side on which the magnetic layer is formed.

For the powder-like composition, various types of inorganic pigment or carbon black can be used, and for the binder resins such as nitrocellulose, phenoxy resin, PVC resins, polyurethane resins and the like can be used either singly or in combinations thereof.

Also, it is possible to provide an adhesive layer on the surface of the support on the side which the alloy particle containing liquid is coated or the surface of the support on the side which the back coat layer is formed.

The magnetic recording medium of the present invention preferably has a center line average surface roughness of 0.1 to 5 nm, more preferably of 1 to 4 nm, with respect to a roughness width cutoff value of 0.25 mm. Surfaces with such exceptional smoothness are preferred for high-density magnetic recording media.

The method of forming such a surface may include the step of performing calendering treatment after the formation of the magnetic layer. Alternatively, varnish treatment may be performed.

[Manufacturing Method of the Magnetic Recording Medium]

The method of manufacturing the magnetic recording medium of the invention comprises: making alloy particles, using a liquid phase method or a vapor phase method to make alloy particles that can have a ferromagnetic ordered alloy phase; forming magnetic regions, by using a mask that uses a photopolymer to form the magnetic regions; then, annealing the magnetic regions after they have been formed. Also it is preferable, as required, after making the alloy particles and before forming the magnetic regions, or during the forming of the magnetic regions, oxidation treatment can be carried out to oxidize the alloy particles. Below, the manufacturing method of the magnetic recording medium of the invention will be described while explaining each of the above processes.

<Alloy Particle Making Process>

The alloy particles, which will be come the magnetic particles by annealing, can be manufactured by a vapor phase method or liquid phase method. From consideration of the superiority of mass production, the liquid phase method is preferred. Various of the conventionally known methods can be applied as the liquid phase method, but it is preferable that improved methods of these using a reduction method are used, and among reduction methods a reverse micelle method is particularly preferable, since it enables the control of the particle size.

Reverse Micelle Method

The reverse mixture method includes at least the steps of (1) mixing two types of reverse micelle solutions so as to cause a reduction reaction (the reduction step) and (2) performing aging at a specific temperature after the reduction reaction (the aging step).

Each step will be described below.

(1) Reduction Step

First, a mixture of a surfactant-containing water-insoluble organic solvent and an aqueous solution of a reducing agent is prepared as a reverse micelle solution (I).

An oil-soluble surfactant may be used as the surfactant. Examples of such a surfactant include sulfonate type surfactants (such as AEROSOL OT (trade name, manufactured by Wako Pure Chemical Industries, Ltd.)), quaternary ammonium salt type surfactants (such as cetyltrimethylammonium bromide) and ether type surfactants (such as pentaethylene glycol dodecyl ether).

The content of the surfactant in the water-insoluble organic solvent is preferably from 20 to 200 g/l.

The water-insoluble organic solvent for dissolving the surfactant is preferably an alkane, an ether, alcohol or the like.

The alkane is preferably of 7 to 12 carbon atoms. Examples of such an alkane include heptane, octane, isooctane, nonane, decane, undecane, and dodecane. The ether is preferably diethyl ether, dipropyl ether, dibutyl ether, or the like. The alcohol is preferably ethoxyethanol, ethoxypropanol or the like.

One or more of alcohols, polyols, H₂, and compounds having H₂, HCHO, S₂O₆^{2-, H}₂PO₂⁻, BH₄⁻, N₂H₅⁺, H₂PO₃—, or the like may preferably be used alone or in combination as the reducing agent in the aqueous solution.

The amount of the reducing agent in the aqueous solution is preferably from 3 to 50 moles per mole with respect to one mole of the metal salt.

In this process, the mass ratio of water to the surfactant in the reverse micelle solution (I) (water/surfactant) is preferably 20 or less. If such a mass ratio is 20 or less, advantageously, precipitation can be suppressed, and the particle size can easily be uniform. The mass ratio is more preferably 15 or less, even more preferably from 0.5 to 10.

Another mixture of a surfactant-containing water-insoluble organic solvent and an aqueous solution of a metal salt is independently prepared as a reverse micelle solution (II).

The conditions of the surfactant and the water-insoluble organic solvent (such as materials for use and concentration) may be the same as those of the reverse micelle solution (I).

The type of the reverse micelle solution (II) for use may be the same as or different from that of the reverse micelle solution (I). Similarly, the mass ratio of water to the surfactant in the reverse micelle solution (II) may be the same as or different from that of the micelle solution (I).

It is preferred that the metal salt for forming the aqueous solution should be appropriately selected in such a manner that the magnetic particles can form a CuAu- or Cu₃Au-type ferromagnetic ordered alloy.

Examples of the CuAu-type ferromagnetic ordered alloy include FeNi, FePd, FePt, CoPt, and CoAu. Particularly preferred are FePd, FePt and CoPt.

Examples of the Cu₃Au-type ferromagnetic ordered alloy include Ni₃Fe, FePd₃, Fe₃Pt, FePt₃, CoPt₃, Ni₃Pt, CrPt₃, and Ni₃Mn. Particularly preferred are FePd₃, FePt₃, CoPt₃, Fe₃Pd, Fe₃Pt, and CO₃Pt.

Examples of the metal salt include H₂PtCl₆, K₂PtCl₄, Pt(CH₃COCHCOCH₃)₂, Na₂PdCl₄, Pd(OCOCH₃)₂, PdCl₂, Pd(CH₃COCHCOCH₃)₂, HAuCl₄, Fe₂(SO₄)₃, Fe(NO₃)₃, (NH₄)₃Fe(C₂O₄)₃, Fe(CH₃COCHCOCH₃)₃, NiSO₄, CoCl₂, and Co(OCOCH₃)₂.

The concentration of the aqueous metal salt solution is preferably from 0.1 to 1000 μmol/ml, more preferably from 1 to 100 μmol/ml (in terms of the concentration of the metal salt).

By appropriate selection of the above metal salts, alloy particles can be manufactured, which can form CuAu-type or Cu₃Au-type ferromagnetic ordered alloys, formed by the alloying of metals with low redox potential and metals with high redox potential.

The alloy phase of the alloy particles should be transformed from the disordered phase to the ordered phase by annealing as described below. A third element such as Cu, Ag, Sb, Pb, Bi, Zn, and In is preferably added to the above binary alloy for the purpose of lowering the transforming temperature. A precursor of each third element is preferably added to the metal salt solution in advance. The third element is preferably added in an amount of 1 to 30 at %, more preferably of 5 to 20 at %, based on the amount of the binary alloy.

The reverse micelle solutions (I) and (II) prepared as shown above are mixed. Any mixing method may be used. For example, a preferred method includes adding the reverse micelle solution (II) to form a mixture while stirring the reverse micelle solution (I), in consideration of uniformity in reduction. After the mixing is completed, a reduction reaction is allowed to proceed, in which the temperature is preferably kept constant in the range from −5 to 30° C.

When the reduction temperature is from −5 to 30° C., the problem of unevenness in reduction reaction by condensation of the aqueous phase can be eliminated, and the problem of easily causing aggregation or precipitation and making the system unstable can also be eliminated. The reduction temperature is preferably from 0 to 25° C., more preferably from 5 to 25° C.

Herein, the “constant temperature” means that when the target temperature is set at T (° C.), the temperature of the reduction reaction is in the range of T±3° C. Even in such a case, T also should have upper and lower limits in the above reduction temperature range (from −5 to 30° C.).

The time period of the reduction reaction should be appropriately set depending on the amount of the reverse micelle solution and the like, and is preferably from 1 to 30 minutes, more preferably from 5 to 20 minutes.

The reduction reaction has a significant effect on monodispersion of the particle size distribution and thus is preferably performed with high speed stirring.

A stirrer with high shearing force is preferably used. Specifically, such a preferred stirrer comprises: an agitating blade basically having a turbine or puddle type structure; a structure of a sharp blade attached to the end of the agitating blade or placed at the position in contact with the agitating blade; and a motor for rotating the agitating blade. Useful examples thereof include Dissolver (trade name, manufactured by TOKUSHU KIKA KOGYO CO., LTD.), Omni-Mixer (trade name, manufactured by Yamato Scientific Co., Ltd.), and a homogenizer (manufactured by SMT Company). A stable dispersion of monodisperse alloy particles can be prepared using any of these stirrers.

At least one dispersing agent having one to three amino or carboxyl groups is preferably added to at least one of the reverse micelle solutions (I) and (II), in an amount of 0.001 to 10 moles per mole of the alloy particles to be prepared.

If such a dispersing agent is added, more monodisperse aggregation-free alloy particles can be produced. When the addition amount is from 0.001 to 10 moles, the monodispersion of the alloy particles can further be improved while aggregation can be suppressed.

For the above dispersant, preferably used are organic compounds containing groups which can adsorb to the surface of the alloy particles. Specifically, compounds with one to three of amino groups, carboxyl groups, sulfonic acid groups or sulfinic acid groups can be used separately or in combinations.

Specific examples of the dispersing agent include the compounds represented by the structural formula: R—NH₂, NH₂—R—NH₂, NH₂—R(NH₂)—NH₂, R—COOH, COOH—R—COOH, COOH—R(COOH)COOH, R—SO₃H, SO₃H—R—SO₃H, SO₃H—R(SO₃H)—SO₃H, R—SO₂H, SO₂H—R—SO₂H, or SO₂H—R(SO₂H)—SO₂H. In each formula, R is a straight chain, branched or cyclic, saturated or unsaturated hydrocarbon.

A particularly preferred dispersing agent is oleic acid, which is a known surfactant for colloid stabilization and has been used to protect particles of a metal such as iron. The relatively long chain of oleic acid can provide significant steric hindrance so as to cancel the strong magnetic interaction between particles. For example, oleic acid has an 18-carbon atom chain and a length of 20 angstroms (2 nm) or less. Oleic acid is not aliphatic but has a single double bond.

A similar long-chain carboxylic acid such as erucic acid and linolic acid may also be used as well as oleic acid. One or more of the long-chain organic acids having 8 to 22 carbon atoms may be used alone or in combination. Oleic acid is preferred because it is inexpensive and easily available from natural sources such as olive oil. Oleylamine, a derivative of oleic acid, is also a useful dispersing agent as well as oleic acid.

In a preferred mode of the above reduction step, a metal with a lower redox potential (hereinafter also simply referred to as “low-potential metal”) such as Co, Fe, Ni, and Cr (a metal with a potential of about −0.2 V (vs. N.H.E)) or less is reduced in the CuAu- or Cu₃Au-type ferromagnetic ordered alloy phase and precipitated in a minimal size and in a monodisperse state. Thereafter, in a preferred mode of the temperature rise stage and the aging step as described below, a metal with a high redox potential (hereinafter also simply referred to as “high-potential metal”) such as Pt, Pd and Rh (a metal with a potential of about −0.2 V (vs. N.H.E)) or more is reduced by the precipitated low-potential metal, which serves as a nucleus, at its surface, and replaced and precipitated. The ionized low-potential metal can be reduced again by the reducing agent and precipitated. Such cycles produce alloy particles capable of forming the CuAu- or Cu₃Au-type ferromagnetic ordered alloy.

(2) Aging Step

After the reduction reaction is completed, the resulting solution is heated to an aging temperature.

The aging temperature is preferably a constant temperature of 30 to 90° C. Such a temperature should be higher than the temperature of the reduction reaction. The aging time period is preferably from 5 to 180 minutes. If the aging temperature and the aging time shift to a higher temperature side from the above range, aggregation or precipitation tend to occur. However, if the temperature and time shift to a lower temperature side, then a change in composition due to an incomplete reaction may occur. The aging temperature and the aging time are preferably from 40 to 80° C. and from 10 to 150 minutes, respectively, more preferably from 40 to 70° C. and from 20 to 120 minutes, respectively.

Herein, the “constant temperature” has the same meaning as in the case of the reduction temperature (provided that the phrase “reduction temperature” is replaced by the phrase “aging temperature”). Particularly in the above range (from 30 to 90° C.), the aging temperature is preferably 5° C. or more, more preferably 10° C. or more higher than the reduction reaction temperature. If the aging temperature is 5° C. or more higher than the reduction temperature, the composition as prescribed can be obtained easily.

In the aging step as shown above, the high-potential metal is deposited on the low-potential metal which is reduced and precipitated in the reduction step.

Specifically, the reduction of the high-potential metal occurs only on the low-potential metal, and the high-potential metal and the low-potential metal are prevented from precipitating separately. Thus, the alloy particles capable of forming the CuAu- or Cu₃Au-type ferromagnetic ordered alloy can be efficiently prepared in high yield and in the composition ratio as prescribed so that they can be controlled to have the desired composition. A desired particle size of the alloy particles can be obtained by appropriately controlling the agitation speed during the aging process.

After the aging is performed, a washing and dispersing process is preferably performed, which includes the steps of: washing the resulting solution with a mixture solution of water and a primary alcohol; then performing a precipitation treatment with a primary alcohol to produce a precipitate; and dispersing the precipitate in an organic solvent.

Such a washing and dispersing process can remove impurities so that the applicability of the coating for forming the magnetic layer of the magnetic recording medium can further be improved.

The washing step and the dispersing step should each be performed at least once, preferably twice or more.

Any primary alcohol may be used in the washing, and methanol, ethanol or the like is preferred. The mixing ratio (water/primary alcohol) by volume is preferably in the range from 10/1 to 2/1, more preferably from 5/1 to 3/1. By setting the mixing ratio (water/primary alcohol) by volume in the range from 10/1 to 2/1, the surfactant can easily be removed, and occurrence of aggregation of surfactant can be depressed.

Thus, a dispersion that comprises the alloy particles dispersed in the solution (an alloy particle-containing liquid) is obtained. The alloy particles are monodispersed and thus can be prevented from aggregating and can maintain a uniformly dispersed state even when applied to a support. The respective alloy particles can be prevented from aggregating even when annealed, and thus they can efficiently be ferro-magnetized and have good suitability for coating.

The diameter of the alloy particles before oxidation processing, which will be described later, is preferably small from the perspective of being able to lower noise, but if it is too small then after annealing the particles can become superparamagnetic, and not suitable for magnetic recording. Generally, it is preferable that the diameter is between 1 to 100 nm, more preferably 1 to 20 nm and most preferably 3 to 10 nm.

Reduction Method

There are various reduction methods for producing the alloy particles capable of forming the CuAu- or Cu₃Au-type ferromagnetic ordered alloy. It is preferred to use a method including the step of reducing at least a metal with a lower redox potential (referred to below as a low-potential metal) and a metal with a high redox potential (referred to below as a high-potential metal) with a reducing agent or the like in an organic solvent, water or a mixture solution of an organic solvent and water.

The low-potential metal and the high-potential metal may be reduced in any order or may be reduced at the same time.

An alcohol, a polyalcohol or the like may be used as the organic solvent. Examples of the alcohol include methanol, ethanol and butanol. Examples of the polyalcohol include ethylene glycol and glycerol.

Examples of the CuAu- or Cu₃Au-type ferromagnetic ordered alloy are the same as those in the case of the above reverse micelle method.

The method of preparing the alloy particles through first-precipitation of the high-potential metal may employ the process disclosed in paragraphs 18 to 30 of JP-A No. 2003-73705, the disclosure of which is incorporated by reference herein.

The metal with a high redox potential is preferably Pt, Pd, Rh, or the like. Such a metal may be used by dissolving H₂PtCl₆.6H₂O, Pt(CH₃COCHCOCH₃)₂, RhCl₃.3H₂O, Pd(OCOCH₃)₂, PdCl₂, Pd(CH₃COCHCOCH₃)₂, or the like in a solvent. The concentration of the metal in the solution is preferably from 0.1 to 1000 μmol/ml, more preferably from 0.1 to 100 μmol/ml.

The metal with a lower redox potential is preferably Co, Fe, Ni, or Cr, particularly preferably Fe or Co. Such a metal may be used by dissolving FeSO₄.7H₂O, NiSO₄.7H2O, CoCl₂.6H₂O, Co(OCOCH₃)₂.4H₂O, or the like in a solvent. The concentration of the metal in the solution is preferably from 0.1 to 1000 μmol/ml, more preferably from 0.1 to 100 μmol/ml.

Similarly to the above reverse micelle method, a third element is preferably added to the binary alloy to lower the transforming temperature for the ferromagnetic ordered alloy. The addition amount may be the same as that in the reverse micelle method.

For example, the low-potential metal and the high-potential metal are reduced and precipitated in this order using a reducing agent. In such a case, a preferred process includes reducing the low-potential metal or the low-potential metal and part of the high-potential metal with a reducing agent having a reduction potential lower than −0.2 V (vs. N.H.E); adding the product of the reduction to the high-potential metal source and reducing it with a reducing agent having a redox potential higher than −0.2 V (vs. N.H.E); and then performing a reduction with a reducing agent having a reduction potential lower than −0.2 V (vs. N.H.E).

The redox potential depends on the pH of the system. Preferable examples of the reducing agent having a redox potential higher than −0.2 V (vs. N.H.E) include alcohols such as 1,2-hexadecanediol, glycerols; H₂, and HCHO.

Preferable examples of the reducing agent having a potential lower than −0.2 V (vs. N.H.E) include S₂O₆²⁻, H₂PO₂⁻, BH₄⁻, N₂H₅⁺, and H₂PO₃⁻.

In a case where a zero-valence metal compound such as Fe carbonyl is used as the raw material for the low-potential metal, the reducing agent for the low-potential metal does not have to be used.

The high-potential metal may be reduced and precipitated in the presence of an adsorbent so that the alloy particles can be stably prepared. The adsorbent is preferably a polymer or a surfactant.

Examples of the type of the polymer include polyvinyl alcohol (PVA), poly(N-vinyl-2-pyrolidone) (PVP) and gelatin. PVP is preferred.

The molecular weight of the polymer is preferably from 20,000 to 60,000, more preferably from 30,000 to 50,000. The amount of the polymer is preferably from 0.1 to 10 times, more preferably from 0.1 to 5 times the mass of the alloy particles to be produced.

The surfactant used as an adsorbent preferably includes an “organic stabilizing agent” which is a long-chain organic compound represented by the general formula: R—X, wherein R is a “tail group” of a linear or branched hydrocarbon or fluorocarbon chain and generally has 8 to 22 carbon atoms; and X is a “head group” which is a part for providing a specific chemical bond to the alloy particle surface and preferably any one of sulfinate (—SOOH), sulfonate (—SO₂OH), phosphinate (—POOH), phosphonate (—OPO(OH)₂), carboxylate, and thiol.

The organic stabilizing agent is preferably any one of a sulfonic acid (R—SO₂OH), a sulfinic acid (R—SOOH), a phosphinic acid (R₂POOH), a phosphonic acid (R—OPO(OH)₂), a carboxylic acid (R—COOH), and a thiol (R—SH). Oleic acid is particularly preferred as in the reverse micelle method.

A combination of the phosphine and the organic stabilizing agent (such as triorganophosphine/acid) can provide good controllability for the growth and stabilization of the particles. Didecyl ether or didodecyl ether may also be used. Phenyl ether or n-octyl ether is preferably used as the solvent in terms of low cost and high boiling point.

The reaction is preferably performed at a temperature in the range from 80 to 360° C., more preferably from 80 to 240° C., depending on the necessary alloy particles and the boiling point of the necessary solvent. When the temperature is in the range from 80 to 360° C., well controllable growth of particles can be facilitated, and the formation of undesired by-products can be inhibited.

The particle diameter of the alloy particles is preferably 1 to 100 nm, more preferably 3 to 20 nm, and still more preferably 3 to 10 nm, as in the case of alloy particles prepared by the reverse micelle method.

For a method to increase the particles size (particle diameter), an effective method is a seed crystal method. It is preferable that, in order to increase the recording volume, the alloy particles used for the magnetic recording medium are packed with maximum density. In order to do this, the standard deviation of the alloy particle size is preferably less than 10% of the mean particle size, and more preferably 5% or less. It is preferable that the coefficient of variation of the particle size is less than 10% and more preferably 5% or less.

If the particle size is too small they become superparamagnetic and this is not preferable. And so, as has been stated above, a seed crystal method can be used to increase the size of the particles. In this case, it is possible that a metal which is of higher redox potential than the metal comprising the particles is precipitated. In this case there is a fear of oxidation of the particles and so it is preferable that hydrogenation treatment is carried out on the particles in advance.

It is preferable that the outermost surface of the alloy particles is made from metal of high redox potential from the perspective of preventing oxidation, but since this makes the particles readily aggregate together, in the invention it is preferable to have an alloy of low and high redox potential metals. As has been stated above, such a constitution can be made easily and effectively realized by a liquid phase method.

It is preferable that salts are removed from the liquid after synthesizing the alloy particles in order to improve the stability of dispersion of the alloy particles. De-salting can be carried out by methods of adding an excess of alcohol, causing light aggregation, and then removing the salts together with the supernatant fluid after natural precipitation or precipitation with a centrifuge. However since aggregation can occur easily when using such methods it is preferable to use ultrafiltration methods.

The dispersion of alloy particles in solvent (alloy particle containing liquid) can be obtained as above. In order to prepare the coating liquid for forming the magnetic layer (magnetic layer coating liquid) the above matrix agent can be added to the obtained alloy particle containing liquid. At this time, various additives can be added as required. For the matrix agent one or more of the above types of matrix agent can be added, preferably such that the amount contained is between 0.007 and 1.0 μg/ml, and more preferably such that the amount contained is between 0.01 and 0.7 μg/ml.

A transmission electron microscope (TEM) may be used for evaluation of the diameter of alloy particles. The crystal system of alloy or magnetic particles may be determined by TEM electron diffraction, but is preferably determined by X-ray diffraction in terms of high accuracy. In the composition analysis of the internal portion of alloy or magnetic particles, an EDAX is preferably attached to an FE-TEM capable of finely focusing the electron beam and used for the evaluation. The evaluation of the magnetic properties of the magnetic particles may be made using a VSM (vibrating sample magnetometer).

Oxidation Treatment Step

The alloy particles thus prepared may be subjected to the oxidation treatment. In the oxidation treatment step, the alloy particles are oxidized. If the prepared alloy particles are oxidized, magnetic particles with ferromagnetism can efficiently be produced with no need for high temperature in the later annealing. This can result from the phenomenon as shown below.

In the oxidation of the alloy particles, first, oxygen enters into their crystal lattice. When the oxygen-containing alloy particles are annealed in the state where the oxygen enters into their crystal lattice, the oxygen is released from the crystal lattice by heat. Such release of the oxygen can cause defects, through which the metal atoms which constitutes the alloy become mobile so that the phase transformation can easily occur even at relatively low temperatures.

For example, such a phenomenon can be estimated by EXAFS (Extended X-ray Absorption Fine Structure) measurement of the alloy particles after the oxidized treatment and the magnetic particles after the annealing treatment.

For example, in Fe—Pt alloy particles which have not been subjected to the oxidizing treatment, for example, the existence of a bond between Fe atoms and Pt or Fe atoms can be confirmed.

In the alloy particles which have been subjected to the oxidizing treatment, the existence of a bond between Fe atoms and oxygen atoms can be confirmed, while a bond between Pt and Fe atoms can hardly be found. This means that the Fe—Pt or Fe—Fe bonds have been broken by the oxygen atoms. This suggests that the Pt or Fe atoms become mobile at the time of annealing.

After the alloy particles are annealed, the existence of oxygen cannot be confirmed while the existence of bonds with Pt or Fe atoms can be confirmed around the Fe atoms. It is apparent from the above phenomenon that the phase transformation can slowly proceed without oxidation and that the annealing can require higher temperature without oxidation. It can be considered, however, that excessive oxidation can cause a too strong interaction between oxygen and easy-to-oxidize metals such as Fe so that metal oxides can be produced. Thus, it is important that the oxidation state of the alloy particles should be controlled. Therefore, the oxidation treatment conditions should be optimized.

When the alloy particles are produced by the liquid phase method or the like as described above, for example, the oxidation treatment may be performed by supplying a gas containing at least oxygen (such as oxygen gas and air) to the resulting alloy particle-containing liquid.

At that time, the partial pressure of the oxygen is preferably from 10 to 100%, more preferably from 15 to 50% of the total pressure.

The temperature of the oxidation treatment is preferably from 0 to 100° C., more preferably from 15 to 80° C.

The oxidized state of the alloy particles is preferably evaluated by EXAFS or the like. In view of the cleavage of the Fe—Fe or Pt—Fe bond by oxygen, the number of the bond or bonds between oxygen and the low-potential metal such as Fe is preferably from 0.5 to 4, more preferably from 1 to 3.

Also, for the oxidation treatment, this can be carried out by exposure in air at room temperature (0 to 40° C.), when the above alloy particles are coated on or fixed onto a support or the like. By undertaking the treatment in a state of coating on a support or the like, the aggregation of the alloy particles can be prevented. Regarding the time for the oxidation treatment, this is preferably between 1 and 48 hours, with 3 to 24 hours being more preferable.

Also, it is also possible to carry out the oxidation processing at the time of drying the coating film, after coating of the coating liquid in the process for forming the magnetic regions. At this time it is preferable that the temperature is between 100 and 300° C. And as long as there is oxygen present in the atmosphere, there is no particular restriction to the atmosphere for carrying out the oxidation process, and from the perspective of convenience, it is preferable that it can be carried out in air.

<Process for Forming the Magnetic Regions>

The process for forming the magnetic regions is a process requiring the formation of two or more independent magnetic regions, and can be carried out by treatments such as the above.

<Process of Annealing>

After the formation of the magnetic regions, the alloy particles present in the magnetic regions are of a non-ordered phase. Such a non-ordered phase does not provide ferromagnetism. Thus, in order to form an ordered phase, it is necessary to carry out heat treatment (annealing). In heat treatment, by using Differential Thermal Analysis (DTA), the transformation temperature of the alloy constituting the alloy particles for transformation between ordered to non-ordered is determined. It is necessary that the heat treatment is carried out at a temperature which is at or above this transformation temperature.

The above transformation temperature is usually 500° C., but may be lowered by the addition of a third element. Also, by appropriate changes to the atmosphere of the above oxidation and annealing processes, the transformation temperature can be lowered. Hence it is preferable that the annealing processing temperature is made 150° C. or above, and more preferable that it is made between 150 and 450° C.

Typical examples of magnetic recording media are magnetic recording tapes, and Floppy Disks (trade mark). After forming a magnetic layer on a web-like state of organic support thereof, the former can be processed into tape-like shapes, and the latter can be manufactured by punching out into disc-like shapes. The present invention is effective when organic materials are used for the support, from the perspective of being able to reduce the transformation temperature to the ferromagnetic state, and so it is preferable that the invention is applied to such applications.

For carrying out the annealing processing in the web-like state, it is preferable that the annealing time is short. If the time for annealing is long then a large apparatus is required. For example, if the conveying speed is 50 m/min and the annealing time is 30 minutes then the length of the line will become 1500 m. Here, it is preferable that in the manufacturing method of the magnetic particles of the invention that the annealing processing time is made 10 minutes or less, and 5 minutes or less is more preferable.

In order to reduce the annealing time as above, it is preferable that, as stated above, the atmosphere for carrying out the annealing processing is made a reducing atmosphere. This is effective for preventing distortion of the support, and also effective for preventing the diffusion of impurities from the support.

Also, when annealing processing is carried out in the particle state, then movement of the particles can easily occur, as can fusion. Hence, whilst it is possible to obtain strong coercivity, there is the disadvantage that the particle size increases. Hence, it is preferable to carry out the annealing process in the state of coating on a support, from the perspective of being able to prevent the aggregation of the alloy particles.

Furthermore, by making the magnetic particles by annealing alloy particles on the support, a magnetic recording medium of a magnetic layer formed from such magnetic particles can be provided.

Supports may be inorganic supports and organic supports as long as these supports can be used for magnetic recording media.

Examples of the material for the inorganic support include Al, Mg alloys such as Al—Mg and Mg—Al—Zn, glass, quartz, carbon, silicon, and ceramics. These supports have good resistance to shock, and rigidity suitable for thickness reduction and high speed rotation. Inorganic supports are more resistant to heat than organic supports.

Examples of the material for the organic support include polyesters (such as polyethylene terephthalate and polyethylene naphthalate), polyolefins, cellulose triacetate, polycarbonate, polyamide (including aliphatic polyamide and aromatic polyamides such as aramid), polyimide, polyamideimide, polysulfone, and polybenzoxazole.

It is preferable that the magnetic layer coating liquid is coated onto the support after carrying out the oxidation process for coating the alloy particles on the support.

It is preferably to include the alloy particles in an amount which is the desired concentration (0.01 to 0.1 mg/ml) at this time.

For the method of coating onto the support, the following can be used: air doctor coating, blade coating, rod coating, extrusion coating, air-knife coating, squeeze coating, dip coating, reverse roll coating, transfer roller coating, gravure coating, kiss coating, cast coating, spray coating, spin coating and the like.

For the atmosphere under which the annealing process is carried out, in order to make the phase transformation progress effectively and prevent oxidation of the alloys, it is preferable that it is a non-oxidizing atmosphere such as H₂, N₂, Ar, He, Ne.

In particular, from the perspective of removing oxygen present in the lattice in the oxidation process, a reducing atmosphere, such as methane, ethane, or H₂ is preferable. Furthermore, in order to maintain the particle diameters, it is preferable that the annealing process is carried out in a reducing atmosphere in a magnetic field. Here, with a H₂ atmosphere, in order to prevent explosion, it is preferable that an inert gas is mixed therewith.

Also, in order to prevent the fusion of particles during annealing, it is preferable that, annealing is carried out once at a temperature below the transformation temperature in an inert gas atmosphere, and after carbonizing the dispersing agent, annealing processing is carried out at a temperature above the transformation temperature in a reducing atmosphere. At this time the optimum conditions are when after carrying out the annealing at the temperature below the transformation temperature, a silicon based resin or the like can be coated onto the layer containing the alloy particles, as required, and the annealing at the temperature above the transformation temperature is carried out.

By carrying out the annealing processing above, the alloy particles can be phase-changed from non-ordered phase to ordered phase, and magnetic particles with ferromagnetism can be obtained.

Magnetic particles manufactured in the above way preferably have a coercivity of 95.5 to 398 kA/m (1200 to 5000 Oe). And when used for a magnetic recording medium, considering the compatibility with recording heads, it is preferable that the coercivity is 95.5 to 278.6 kA/m (1200 to 3500 Oe).

Also, it is preferable that the size of the magnetic particles is from 1 to 100 nm, more preferably from 3 to 20 nm and most preferably from 3 to 10 nm.

After forming a magnetic layer on the support, as stated above, the magnetic recording medium of the present invention is manufactured by the forming of a protective layer, a lubricant layer and the like. The manufactured magnetic recording medium can then be used by punching out to a desired size by using a punching out machine, or by cutting to a desired size by using a slitter or the like.

It is possible to apply a method of depositing the desired alloy on a support as the method for forming the layer, which will become the magnetic layer containing the CuAu-type or Cu₃Au-type ferromagnetic ordered alloy (alloy layer) by annealing. This method is not particularly limited, but a method using sputtering film formation is preferable.

There are “RF Magnetron Sputtering Method” (referred to sometimes below as “RF Sputtering Method”), “DC Magnetron Sputtering Method” and “Reactive Sputtering Method”). Any of these methods can be used.

By these sputtering film formation methods, an alloy layer of a structure (granular structure) of magnetic crystalline particles surrounded with non-magnetic material crystalline particles of oxides or nitrides and the like can be formed.

After forming a layer on the support using the above sputtering film forming methods, then the above described oxidation process (oxidizing process exposing with air or the like) and annealing process and the like can be carried out.

### EXAMPLES

The present invention is more specifically described by means of the examples below, but these do not limit the scope of the invention.

### Example 1

Preparation of FePt Alloy Particles

The process as shown below was performed in high purity N₂ gas.

To a reducing agent aqueous solution containing 0.76 g of NaBH₄ (manufactured by Wako Pure Chemical Industries Ltd.) dissolved in 16 ml of water (deoxygenated to 0.1 mg/l or below) was added an alkane solution of a mixture of 10.8 g of Aerosol OT (manufactured by Wako Pure Chemical Industries Ltd.), 80 ml of decane (manufactured by Wako Pure Chemical Industries Ltd.), and 2 ml of oleyl amine, mixed and a reverse micelle solution (I) was thereby prepared.

To a metal salt aqueous solution containing 0.46 g of iron triammonium trioxalate (Fe(NH₃)₃(C₂O₄)₃) (manufactured by Wako Pure Chemical Industries Ltd.), and 0.38 g of potassium platinum chloride (K₂PtCl₄) (manufactured by Wako Pure Chemical Industries Ltd.) dissolved in 12 ml of water (deoxygenated) was added an alkane solution of 5.4 g of Aerosol OT (manufactured by Wako Pure Chemical Industries Ltd.) mixed with 40 ml of decane (manufactured by Wako Pure Chemical Industries Ltd.), and a reverse micelle solution (II) was thereby prepared.

To the reverse micelle solution (I) at 22° C. being high speed stirred in an Omnimixer (manufactured by Yamato Scientific Co. Ltd.) was quickly added the reverse micelle solution (II). After 10 minutes, the temperature was raised to 50° C. while stirring with a magnetic stirrer and was allowed to stand for 60 minutes for aging.

2 ml of Oleic acid (manufactured by Wako Pure Chemical Industries Ltd.) was added to the mixture above and then the solution was cooled to room temperature. After cooling, the resultant mixture solution was taken out into the atmosphere. In order to breakdown the reverse micelle, a mixture solution of 100 ml of water and 100 ml of methanol was added to separate into water and oil phases. Alloy particles were obtained in a dispersed condition in the oil phase. The oil phase was washed 5 times with a mixed solution of 600 ml of water with 200 ml of methanol.

Then, the alloy particles were flocculated by adding 100 ml of methanol to cause precipitation of the particles. The supernatant liquid was removed, 20 ml of heptane (manufactured by Wako Pure Chemical Industries Ltd.) was added and re-dispersion was carried out.

Precipitation with 100 ml of methanol and dispersion with 20 ml of heptane was carried out a further 2 times, and finally 5 ml of heptane was added, and an alloy particle containing liquid which contains FePt alloy particles and a surfactant in which the ratio of water to the surfactant (water/surfactant) of 2 by mass was prepared.

The yield, composition, volume average particle diameter and distribution (variation coefficient) of the resultant alloy particles were measured, and the following results were obtained.

The composition and yield were determined by the measurement by ICP spectroscopic analysis (inductive coupling high frequency plasma spectroscopic analysis).

Volume average particle diameter and size distribution were determined by measuring microscopic photographic images of particles taken with a TEM (transmission type electron microscope: Hitachi Ltd.; 300 kV) and processing the measured data statistically.

For the measurement of the alloy particles, the alloy particles collected from the prepared alloy particle solution were thoroughly dried, and used after heating the particles in an electric oven.
Composition: FePt alloy with Pt 44.5 at %; Yield: 85%
Average particle diameter: 4.2 nm, Variation coefficient: 5%
   (Preparation of the Coating Liquid)

The alloy particle-containing liquid was evacuated to concentrate to a concentration of 12% by mass of the alloy particles. Decane was added thereto to dilute to a 4% concentration by mass.

Thereafter, a liquid of TOREFIL R910 (trade name; manufactured by Toray Industries Inc.) as a matrix agent at a concentration of 1% by mass dissolved in the decane solution was added to the alloy particle-containing liquid in amounts per 1 ml of the alloy particle-containing liquid as shown in Table 1 below, and, after stirring, filtered in a clean room to prepare coating liquids.

(Magnetic Region Forming Process)

(1) A carbon layer was formed as a matrix layer by sputtering onto a hard disk glass support (65/20−0.635t glass/polish/substrate, manufactured by Toyo Seikan Kaisha Ltd.). The thickness of the layer was 50 nm.

(2) Next, SAITOP (trade name; manufactured by Asahi Glass) was coated at a thickness of 100 μm to form a resist film.

(3) The resist film was exposed with ultra-violet light according to a bit pattern to form a patterned mask having a bit pattern array. The bit pattern was a 500 nm by 500 nm pattern with a pattern spacing distance of 100 nm.

(4) A reactive ion etching method was used for selectively etching areas of the matrix layer which were not covered by the patterned mask, and a matrix mask layer was formed with the bit array pattern which was built into the resist mask.

(5) A coating liquid containing the prepared alloy particles to become ferromagnetic bodies dispersed therein was coated by the spin coating method in air.

(6) The regions (coated layer) including the alloy particles to become the ferromagnetic ordered alloy were hardened by heating to 200° C. in air, and the alloy particles to become ferromagnetic bodies were oxidized.

(7) The patterned mask as a resist mask was dissolved away using an appropriate solvent (water containing 20 ppm or more of ozone).

(Annealing Processing and the Like)

Annealing processing is carried out by raising the temperature at a rate of 50° C. per minute, in an atmosphere of an H₂ and Ar mixed gas (H₂: Ar=5:95) in an electric oven (450° C.) for 30 minutes, and then reducing the temperature at a rate of 50° C. per minute to room temperature to form the regions of ferromagnetic bodies. The thickness of the film was 50 nm.

Then, a carbon protective layer was formed by sputtering at a thickness of 5 nm. A solution containing 1% by mass of Fomblin Z Sol (trade name, manufactured by Aussimont KK) in a solvent (Florinert™FC72) was prepared, and coating is carried out using a dip coater by raising out of the solution at a rate of 10 mm/min, a lubricant layer was formed on the protective layer, and thus the magnetic recording medium was prepared.

### Examples 2 to 6 and Comparative Examples 1 and 2

Magnetic recording media of Examples 2 to 6 and Comparative Examples 1 and 2 were prepared in the same way as Example 1 except that the amount of the matrix agent and the selective etching in the magnetic region forming process in Example 1 ((4) in Example 1) were changed as shown in Table 1 below.

Edge sections of the magnetic recording media were cut out using a FIB (model name SMI2050, manufactured by Seiko Instruments Ltd.), and the cut edges were observed using a transmission electron microscope (model number H9000, manufactured by Hitachi Ltd.) at an acceleration voltage of 300 kV. Evaluation was carried out on the configuration of the magnetic regions and the arrangement of the magnetic particles (particle arrangement). The results of the evaluation are shown in Table 1 below.

The magnetic characteristics (coercive force) of the magnetic layers were measured for each of the magnetic recording media. The conditions used for carrying out these measurement were: after applying a magnetic field of 40 kOe in the inward direction using a magnetizing device including a solenoid (model number MPM40, manufactured by Toei Industry Co. Ltd.), a highly sensitive vector magnetometer and DATA processing equipment (also manufactured by Toei Industry Co. Ltd.) are used, with an applied magnetic field of 790 kA/m (10 kOe). The coercive force was about 3000 Oe.

TABLE 1

| | Amount of | Selective etching | | |
|---|---|---|---|---|
| | Matrix Agent | (4) carried out? | Formation of the magnetic | Arrangement of the |
| | (μ liters) | Y/N | regions | particles |
| Example 1 | 13.5 | Y | Formed in depressions in | Self-organized |
| | | | the matrix layer (state as | |
| | | | in FIG. 2 (E)) | |
| Example 2 | 54 | Y | Formed in depressions in | Random |
| | | | the matrix layer (state as | |
| | | | in FIG. 2 (E)) | |
| Example 3 | 108 | Y | Formed in depressions in | Random |
| | | | the matrix layer (state as | |
| | | | in FIG. 2 (E)) | |
| Example 4 | 13.5 | N | Formed on protrusions | Self-organized |
| | | | on the matrix layer (state | |
| | | | as in FIG. 3 (E′)) | |
| Example 5 | 54 | N | Formed on protrusions | Random |
| | | | on the matrix layer (state | |
| | | | as in FIG. 3 (E′)) | |
| Example 6 | 108 | N | Formed on protrusions | Random |
| | | | on the matrix layer (state | |
| | | | as in FIG. 3 (E′)) | |
| Comparative | None | Y | Formed in depressions in | Self-organized |
| Example 1 | | | the matrix layer but the | |
| | | | majority are defective | |
| Comparative | None | N | No magnetic regions are | N/A |
| Example 2 | | | formed | |

From the results in Table 1, it has been found that in all of the Examples, independent magnetic regions were formed, and aggregation of the magnetic particles was prevented, realizing low transition noise. Also, by the provision of the magnetic region forming process, independent magnetic regions were efficiently formed.

According to the present invention, it is possible to provide a magnetic recording medium and manufacturing method thereof with a high productivity wherein aggregation of the magnetic particles is prevented while realizing low transition noise.

What is claimed is:

1. A magnetic recording medium with a magnetic layer on a support containing magnetic regions and non-magnetic regions comprising:
two or more of the magnetic regions, wherein each of the regions contains a ferromagnetic ordered alloy, of either a CuAu-type or Cu₃Au-type, and a matrix agent, and where each of the magnetic regions is formed as a physically separate shape.

2. The magnetic recording medium of claim 1 wherein:
the magnetic regions are formed in depressions formed on the support.

3. The magnetic recording medium of claim 1 wherein:
the ferromagnetic ordered alloy, of either a CuAu-type or Cu₃Au-type, is in the form of magnetic particles which are orderly arranged.

4. The magnetic recording medium of claim 2 wherein:
the ferromagnetic ordered alloy, of either a CuAu-type or Cu₃Au-type, is in the form of magnetic particles which are orderly arranged.

5. The magnetic recording medium of claim 1 wherein:
the matrix agent is at least one nonmagnetic metal oxide compound selected from the group consisting of silica, titania or polysiloxane.

6. The magnetic recording medium of claim 2 wherein:
the matrix agent is at least one nonmagnetic metal oxide compound selected from the group consisting of silica, titania or polysiloxane.

7. The magnetic recording medium of claim 4 wherein:
the matrix agent is at least one nonmagnetic metal oxide compound selected from the group consisting of silica, titania or polysiloxane.

8. A manufacturing method of the magnetic recording medium of claim 1 comprising:
forming magnetic regions using a mask which uses a photopolymer to form the magnetic regions which contain the ferromagnetic ordered alloy, of either a CuAu-type or Cu₃Au-type, and the matrix agent.

9. A manufacturing method of the magnetic recording medium of claim 2 comprising:
forming magnetic regions using a mask which uses a photopolymer to form the magnetic regions which contain the ferromagnetic ordered alloy, of either a CuAu-type or Cu₃Au-type, and the matrix agent.

10. A manufacturing method of the magnetic recording medium of claim 3 comprising:
forming magnetic regions using a mask which uses a photopolymer to form the magnetic regions which contain the ferromagnetic ordered alloy, of either a CuAu-type or Cu₃Au-type, and the matrix agent.

11. A manufacturing method of the magnetic recording medium of claim 4 comprising:
forming magnetic regions using a mask which uses a photopolymer to form the magnetic regions which contain the ferromagnetic ordered alloy, of either a CuAu-type or Cu₃Au-type, and the matrix agent.

12. A manufacturing method of the magnetic recording medium of claim 7 comprising:
forming magnetic regions using a mask which uses a photopolymer to form the magnetic regions which contain the ferromagnetic ordered alloy, of either a CuAu-type or Cu₃Au-type, and the matrix agent.

13. The magnetic recording medium manufacturing method of claim 8 wherein:
the photopolymer is at least one polymer selected from the group consisting of polyterafluoroethylene, a copolymer of tetrafluoroethylene and perfluoroalkoxy vinyl ether, and a copolymer of ethylene and terafluoroethylene).

14. The magnetic recording medium manufacturing method of claim 9 wherein:
the photopolymer is at least one polymer selected from the group consisting of polyterafluoroethylene, a copolymer of tetrafluoroethylene and perfluoroalkoxy vinyl ether, and a copolymers of ethylene and terafluoroethylene).

15. The magnetic recording medium manufacturing method of claim 10 wherein:
the photopolymer is at least one polymer selected from the group consisting of polyterafluoroethylene, a copolymer of tetrafluoroethylene and perfluoroalkoxy vinyl ether, and a copolymer of ethylene and terafluoroethylene).

16. The magnetic recording medium manufacturing method of claim 11 wherein:
the photopolymer is at least one polymer selected from the group consisting of polyterafluoroethylene, a copolymer of tetrafluoroethylene and perfluoroalkoxy vinyl ether, and a copolymer of ethylene and terafluoroethylene).

17. The magnetic recording medium manufacturing method of claim 12 wherein:
the photopolymer is at least one polymer selected from the group consisting of polyterafluoroethylene, a copolymer of tetrafluoroethylene and perfluoroalkoxy vinyl ether, and a copolymer of ethylene and terafluoroethylene).

18. The magnetic recording medium of claim 1 wherein:
the particle diameter of the ferromagnetic ordered alloy, of either a CuAu-type or Cu₃Au-type, is from about 5 to about 10 nm and the coefficient of variation of the particle diameter is about 10% or less.

19. The method for manufacturing the magnetic recording medium of claim 1 wherein:
the ferromagnetic ordered alloy, of either a CuAu-type or Cu₃Au-type is synthesized by a liquid phase method.

20. The method for manufacturing the magnetic recording medium of claim 1 wherein:
the ferromagnetic ordered alloy, of either a CuAu-type or Cu₃Au-type is coated on a support.
